(19) United States
(12) Patent Application Publication
(10) Pub. No.: US 2010/0029208 A1
(43) Pub. Date: Feb. 4, 2010

(54) Host apparatus for supporting bluetooth and method therefor

(75) Inventors: Hyang-Bok Lee, Suwon-si (KR); Hark-Soo Kim, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/462,103

(22) Filed: Jul. 29, 2009

(30) Foreign Application Priority Data
Jul. 31, 2008 (KR) 10-2008-0075321

(51) Int. Cl. H04B 7/00; H04B 3/00

(52) U.S. Cl. 455/41.3; 381/77

(57) ABSTRACT

A host apparatus for wirelessly communicating with a headset by Bluetooth® is provided. An audio Digital Signal Processor (DSP) performs Pulse Code Modulation (PCM) on sound source data when a type of the headset is a mono headset. The audio DSP performs Universal Asynchronous Receiver Transmitter (UART) modulation on the sound source data when a type of the headset is not a mono headset. A Bluetooth® communication unit transmits the data modulated by the audio DSP to the headset.

### CROSS-REFERENCE TO RELATED APPLICATION(S) AND CLAIM OF PRIORITY

The present application claims the benefit under 35 U.S.C. §119(a) of a Korean Patent Application filed in the Korean Intellectual Property Office on Jul. 31, 2008 and assigned Serial No. 10-2008-0075321, the entire disclosure of which is hereby incorporated by reference.

### TECHNICAL FIELD OF THE INVENTION

The present invention relates generally to a host apparatus for supporting Bluetooth®. More particularly, the present invention relates to a method and host apparatus for providing sound source data to a Bluetooth® mono headset.

### BACKGROUND OF THE INVENTION

Bluetooth® is one of the wireless interface standard specifications for connection between a portable device and other peripheral devices. The portable device corresponds to a mobile phone, a portable Personal Computer (PC) and the like. The peripheral devices include all devices serving as a network access point. Modules supporting Bluetooth® are advantageous in that they are small in size, low in price, and consume less power.

Recently, with the development of mobile terminal-related technologies and multimedia services, functions offered by mobile terminals are diversified. Additionally, sound source services provided by the mobile terminals are also increased in diversity. Accordingly, there is a tendency that a category of the mobile terminals where the sound source services are provided is extended and various types of mobile terminals provide Bluetooth® communication as a basic function. As a result, wireless communication is possible between a Bluetooth® wireless headset and the mobile terminal so that a user may readily transmit and receive information of the mobile terminal using the headset.

However, the conventional mono headset has a limitation in providing various multimedia services. Commonly, it is not possible for the mono headset to normally replay sound source data since it cannot demodulate the data that is modulated by a transmission scheme for supporting a stereo headset. Thus, a user of the low-priced mono headset that is conveniently carried by the user for a voice call purpose cannot listen to the sound source data. As a result, the user may not listen to even linguistic sound source data that does not need high sound quality, as well as the high-sound quality music.

A mono headset, which has recently been produced and distributed in the market, has a Bluetooth® module for supporting a stereo headset to allow the user to listen to sound source data. However, such a product should necessarily have a built-in Bluetooth® module for supporting the stereo headset in order to perform Bluetooth® communication, significantly increasing its implementation cost.

### SUMMARY OF THE INVENTION

To address the above-discussed deficiencies of the prior art, it is a primary aspect of the present invention to provide a host apparatus for allowing a user to listen to sound source data that he could not listen to conventionally, using a mono headset supporting Bluetooth®, and a method there for.

Another aspect of the present invention provides a host apparatus for modulating sound source data that cannot be listened to with a mono headset, to allow a user to listen to the sound source data using a mono headset supporting Bluetooth®, and a method there for.

Further another aspect of the present invention provides a host apparatus for Pulse Code Modulation (PCM)-modulating sound source data that cannot be listened to with a mono headset and transmitting the modulated sound source data to a mono headset supporting Bluetooth®, and a method there for.

Yet another aspect of the present invention provides a host apparatus for changing a scheme of modulating sound source data according to a type of a headset supporting Bluetooth®, and a method there for.

According to one aspect of the present invention, there is provided a host apparatus for wirelessly communicating with a headset by Bluetooth®. The apparatus includes an audio Digital Signal Processor (DSP) for performing PCM on sound source data when a type of the headset is a mono headset, and a Bluetooth® communication unit for transmitting the data modulated by the audio DSP to the headset.

According to another aspect of the present invention, there is provided a method for wirelessly communicating with a headset by Bluetooth® in a host apparatus. The method includes performing PCM on sound source data when a type of the headset is a mono headset, and transmitting the PCM-modulated data to the headset.

According to further another aspect of the present invention, there is provided a Bluetooth® system including a headset used for listening to sound source data received by Bluetooth®, and a host apparatus for performing PCM on sound source data and transmitting the modulated sound source data to the headset when a type of the headset is a mono headset.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a host apparatus according to an exemplary embodiment of the present invention; and

FIG. 2 illustrates a process of replaying and outputting sound source data to a Bluetooth® headset according to an exemplary embodiment of the present invention.

Throughout the drawings, the same drawing reference numerals will be understood to refer to the same elements, features and structures.

### DETAILED DESCRIPTION OF THE INVENTION

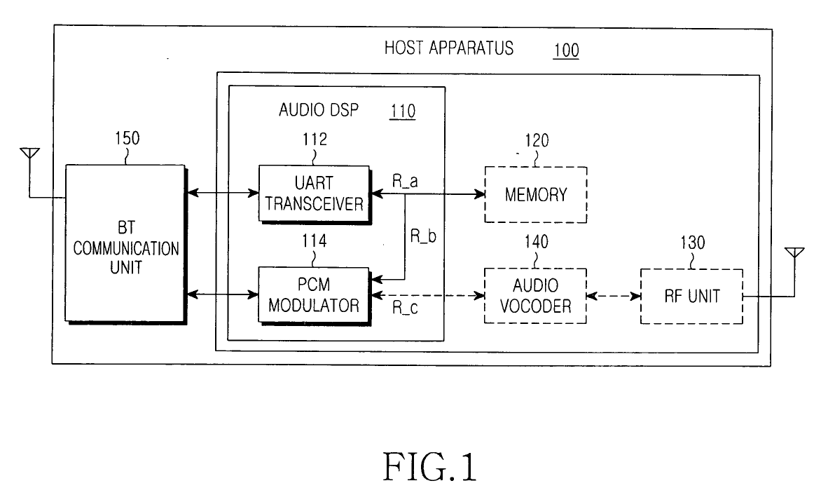

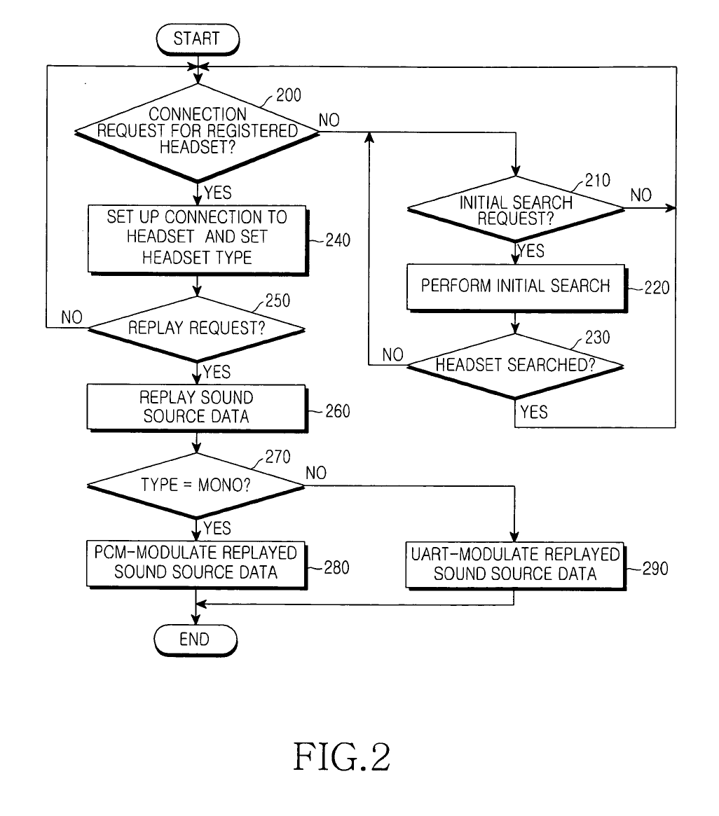

FIGS. 1 through 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communications device.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before a detailed description of the invention is given, it is to be understood that the term ‘host’ as used herein refers to a device that provides sound source data and/or a voice call signal to a headset by performing Bluetooth communication with the headset. The host may include not only mobile terminals such as a mobile phone, a Personal Digital Assistant (PDA), a laptop computer and an MPEG Audio Layer-3 (MP3) player, but also a desk top computer that is difficult to carry and a car Audio/Video (A/V) system as long as they can perform Bluetooth communication with the headset. In the following description, a mobile communication terminal will be given as an example of a host apparatus for convenience purpose only.

A Bluetooth® headset, an audio input/output device of a Bluetooth® host apparatus, is wirelessly coupled and can provide audio data while on the move. The headset can be roughly classified into a stereo headset and a mono headset.

Moreover, the term ‘sound source data’ as used herein indicates that the data is not a voice call signal that a host apparatus receives with a Radio Frequency (RF) unit, and the sound source data may include files recorded in various formats by a voice recorder, in addition to an MP3 file, a Window Media Audio (WMA) file and/or a Wave (WAV) file.

Wireless communication performed between a host apparatus and a headset is herein assumed to be Bluetooth® wireless communication.

FIG. 1 illustrates a structure of a host apparatus 100 according to an exemplary embodiment of the present invention.

A host apparatus 100 includes an audio Digital Signal Processor (DSP) 110 for modulating and controlling sound source data and/or a call signal, a memory 120 for storing sound source data and outputting the sound source data upon request, an RF unit 130 for transmitting and receiving a call signal, an audio vocoder 140 for analyzing and synthesizing a call signal into an electrical signal, and a Bluetooth® (BT) communication unit 150 for encoding modulated sound source data with a Sub Band Codec (SBC) codec and transmitting the encoded sound source data to a headset.

However, the host apparatus 100, if it does not support a call function, may not include the audio vocoder 140 and the RF unit 130. An example of the host apparatus 100 supporting the call function may include a mobile phone, a PDA and the like. An example of the host apparatus 100 not supporting the call function may include a laptop computer, an MP3 player and the like. This classification is merely given by way of example, and the decision should be made depending on whether the host apparatus has a voice call function.

In addition, when replayed sound source data is not the data stored in the memory 120 of the host apparatus 100, the host apparatus 100 may not include the memory 120. There are several possible examples of excluding the memory 120. For example, the host apparatus 100 may not include the memory 120 when the sound source data received in a streaming form through the RF unit 130 is replayed by the audio DSP 110. Also, the host apparatus 100 may not include the memory 120, when an external memory is connected to the host apparatus 100 and sound source data stored in the external memory is directly replayed by the audio DSP 110 without being stored in the host apparatus 100.

The audio DSP 110 controls the overall operation of modulating sound source data. The audio DSP 110 may include a Universal Asynchronous Receiver Transmitter (UART) transceiver 112 and a PCM modulator 114. The audio DSP 110 controls to transmit sound source data stored in the memory 120 to the headset. The audio DSP 110 selectively controls its operation according to a type of a connected headset. For example, the audio DSP 110 performs UART modulation and transmission for a stereo headset, and PCM modulation and transmission for a mono headset.

The UART transceiver 112 UART-modulates the replayed sound source data to support a transfer rate of a minimum of 112 Kbps, and transmits the modulated sound source data to the BT communication unit 150.

The PCM modulator 114 PCM-modulates the replayed sound source data with a PCM scheme by which a mono headset can also demodulate the sound source data, and transfers the modulated sound source data to the BT communication unit 150.

The memory 120 may be composed of a program memory and a data memory. The program memory may store programs for controlling an overall operation of the host apparatus 100, and a program for controlling an operation of the audio DSP 110 according to an exemplary embodiment of the present invention. The data memory stores data generated during execution of the above programs and sound source data, and outputs the data upon request.

The RF unit 130 serves to transmit and receive call signals. The RF unit 130 includes an RF transmitter (not shown) for up-converting a frequency of a transmission signal and amplifying the up-converted signal, and an RF receiver (not shown) for low-noise-amplifying a received signal and down-converting a frequency of the amplified signal.

The audio vocoder 140 may constitute a codec, and the codec includes a data codec for processing packet data, and the like, and an audio codec for processing an audio signal such as voice. The audio vocoder 140 has a function of converting and replaying a digital audio signal received from the RF unit 130 into an analog audio signal using the audio codec and transferring the analog audio signal to the audio DSP 110, and a function of receiving, from the audio DSP 110, a call signal that is generated from a microphone of the headset and received at the host apparatus 100, and converting the received call signal into a digital audio signal using the audio codec to transmit the digital audio signal by means of the RF unit 130.

The BT communication unit 150, which is connected to a Bluetooth® wireless communication unit (not shown) included in the headset, performs Bluetooth® wireless communication so that the headset may exchange data with the host apparatus 100.

With reference to FIG. 1, a description will be made of a process of modulating and transmitting sound source data according to an exemplary embodiment of the present invention.

When there is a replay request for sound source data, the conventional host apparatus 100 UART-modulates replayed sound source data. UART, described below, is a transmission scheme that can support a sound quality equivalent to that of an MP3 file. Advanced Audio Distribution Profile (A2DP) is a profile that enables a user to listen not only to a voice call signal, but also to sound source data that is communicated by UART. Therefore, a stereo headset with A2DP can output a stereo sound as well as a mono sound.

On the other hand, a mono headset mostly includes only Headset Profile (HSP) and Hands Free Profile (HFP), without A2DP. Therefore, the mono headset can enable only a voice call based on a PCM data line.

After the UART modulation, the host apparatus 100 encodes the modulated data with an SBC codec. In Bluetooth®, SBC is used as a standard codec. That is, regardless of a type of modulated audio data, the host apparatus 100 encodes the audio data with SBC, which is the Bluetooth® standard codec, and transmits the encoded audio data to the Bluetooth® headset, and the headset decodes the SBC-encoded audio data.

After the encoding with an SBC codec, the host apparatus 100 transmits the SBC-encoded audio data to the Bluetooth® headset using Bluetooth® wireless communication.

Therefore, the sound source data transmitted using UART can be replayed by only a stereo headset and a mono headset with A2DP.

In accordance with an exemplary embodiment of the present invention, when a type of the headset is a stereo headset, the host apparatus 100 UART-modulates and encodes sound source data and transmits the sound source data in the conventional manner (see a path R_a in FIG. 1). However, when a type of the headset is a mono headset, the audio DSP 110 in the host apparatus 100 PCM-modulates the sound source data and delivers the modulated sound source data to the BT communication unit 150, and the BT communication unit 150 encodes the PCM-modulated sound source data with an SBC codec and transmits the encoded sound source data to the Bluetooth® headset (see a path R_b in FIG. 1). As a result, the mono headset without A2DP can replay the sound source data based on a PCM data line.

In case of the host apparatus 100 supporting a call function, the audio vocoder 140 vocodes a call signal received via the RF unit 130, the audio DSP 110 PCM-modulates the vocoded call signal and delivers the modulated call signal to the BT communication unit 150, and the BT communication unit 150 encodes the PCM-modulated call signal with an SBC codec and transmits the encoded call signal to the headset (see a path R_c in FIG. 1).

A comparison will be made between UART and PCM modulation schemes, by which the audio DSP 110 in the host apparatus 100 provides sound source data to a stereo headset.

A general transfer rate of UART ranges from a minimum of 112 Kbps to a maximum of 3 Mbps. Conversely, in case of PCM, a sampling rate at which a voice signal can be restored is about 8 KHz, and general PCM data used in a commercial Bluetooth® module is composed of eight (8) bits. As a result, a transfer rate of PCM is 64 Kbps.

In case of MP3, which is representative sound source data, the data is composed of sixteen (16) bits, and if a sampling rate of 8 KHz is applied, a transfer rate of 128 Kbps is required. If UART supporting a high transfer rate is used, there is no sound quality problem since the required transfer rate (or higher) of MP3 is supported. However, if the data is transmitted after being PCM-modulated, it should undergo down sampling due to a limit (64 Kbps) of the transfer rate, resulting in a sound quality loss of MP3.

However, when listening to linguistic sound source data is intended, replay at a high sound quality is not required, and the mono headset enables listening to sound source data such as MP3 without the need to additionally include hardware and upgrade software. Thus, the sound quality loss is worth enduring.

With reference to FIG. 2, a detailed description will be made of an operation of transmitting and outputting sound source data to a mono headset in the host apparatus 100.

FIG. 2 illustrates a process of replaying and outputting sound source data to a Bluetooth® headset according to an exemplary embodiment of the present invention.

An exemplary embodiment of the present invention will be described in detail with reference to both FIGS. 1 and 2.

A process is included that sets a headset in the host apparatus 100 before transmission of sound source data. Steps 200 through 240 represent a setting process, while steps 250 through 290 correspond to a process of replaying, modulating and outputting sound source data.

When there is a connection request for a headset, the host apparatus 100 determines in step 200 whether the connection request is a connection request for a headset registered therein. A process of making the connection request for a headset includes i) a method of requesting the connection by a headset, and ii) a method of requesting the connection by the host apparatus 100. The former method can be achieved by turning on power of the headset by the user, and the latter method can be realized by activating a connection request function provided in the host apparatus 100 by the user.

If it is determined in step 200 that the connection request is a connection request for a registered headset, the host apparatus 100 sets up a connection to the headset in step 240. The connection setup process includes a process of setting whether a type of the headset is a stereo headset or a mono headset.

However, if it is determined in step 200 that the connection request is a connection request for an unregistered headset, the host apparatus 100 determines in step 210 whether there is a request for initial search. The presence/absence of a request for initial search can be determined by receiving an input from a user. Optionally, if the connection request is a connection request for an unregistered headset in step 200, the host apparatus 100 may automatically perform the next operation without the determination process, considering that there is a request for initial search.

If it is determined in step 210 that there is no request for initial search, the host apparatus 100 returns to step 200 where it determines again whether the connection request is a connection request for a registered headset. However, if there is a request for initial search in step 210, the host apparatus 100 performs initial search in step 220. The initial search process includes a process of registering information about the headset in the host apparatus 100 and a process of setting a result (‘success’ or ‘fail’) of the initial search.

After step 220, the host apparatus 100 determines the result of the initial search in step 230. If the result is ‘success’, the host apparatus 100 returns to step 200 where it determines again whether the connection request is a connection request for a registered headset. However, if the result is ‘fail’, the host apparatus 100 returns to step 210 and waits for a request for initial search.

After completing the connection setup in step 240, the host apparatus 100 determines in step 250 whether there is a replay request for sound source data. If there is no replay request, the host apparatus 100 returns to step 200 and waits in the process of setting up a connection to the headset. However, if there is a replay request for sound source data, the host apparatus 100 proceeds to the next step.

If there is a replay request for sound source data, the host apparatus 100 begins replaying sound source data in step 260.

In step 270, the host apparatus 100 determines whether a type of the headset to which it will output the replayed sound source data is a mono headset.

If it is determined in step 270 that a type of the headset is a mono headset, the audio DSP 110 PCM-modulates the replayed sound source data and outputs the modulated sound source data to the headset in step 280. However, if a type of the headset is not a mono headset, the audio DSP 110 UART-modulates the replayed sound source data and outputs the modulated sound source data to the headset in step 290. The PCM modulation and the UART modulation can be performed by the PCM modulator 114 and the UART transceiver 112, respectively.

The headset, which has received the data output through the Bluetooth wireless communication, outputs the received data.

As is apparent from the foregoing description, the present invention, though it brings about a loss of sound quality, enables listening to musical sound source data and linguistic sound source data without installing separate additional modules even with a mono headset which is easy to carry and use, compared with the stereo headset. Therefore, a user of the mono headset can conveniently use the headset and benefit from a new function added without an increase in cost.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A host apparatus for wirelessly communicating with a headset by Bluetooth®, comprising:
an audio Digital Signal Processor (DSP) for performing Pulse Code Modulation (PCM) on sound source data when a type of the headset is a mono headset; and
a Bluetooth® communication unit for transmitting the data modulated by the audio DSP to the headset.

2. The host apparatus of claim 1, wherein the audio DSP performs Universal Asynchronous Receiver Transmitter (UART) modulation on the sound source data when a type of the headset is not a mono headset.

3. The host apparatus of claim 2, wherein the audio DSP comprises:
a PCM modulator for PCM-modulating the sound source data when a type of the headset is a mono headset; and
a UART transceiver for UART-modulating the sound source data when a type of the headset is not a mono headset.

4. The host apparatus of claim 1, further comprising a memory.

5. The host apparatus of claim 4, wherein the memory is configured to store the sound source data and outputting the stored sound source data to the audio DSP.

6. The host apparatus of claim 1, wherein the host apparatus is configured to support a call function.

7. The host apparatus of claim 1, wherein the host apparatus is any one of a mobile phone, a Personal Digital Assistant (PDA), a laptop computer, and an MPEG Audio Layer-3 (MP3) player.

8. The host apparatus of claim 1, wherein the sound source data is any one of an MP3 file, a Window Media Audio (WMA) file, and a Wave (WAV) file.

9. A method for wirelessly communicating with a headset by Bluetooth® in a host apparatus, comprising:
performing Pulse Code Modulation (PCM) on sound source data when a type of the headset is a mono headset; and
transmitting the PCM-modulated data to the headset.

10. The method of claim 9, further comprising:
performing Universal Asynchronous Receiver Transmitter (UART) modulation on the sound source data when a type of the headset is not a mono headset; and
transmitting the UART-modulated data to the headset.

11. The method of claim 9, further comprising determining whether a type of the headset is a mono headset.

12. The method of claim 9, wherein the sound source data is sound source data stored in a memory.

13. The method of claim 9, wherein the host apparatus is configured to support a call function.

14. The method of claim 9, wherein the host apparatus is any one of a mobile phone, a Personal Digital Assistant (PDA), a laptop computer, and an MPEG Audio Layer-3 (MP3) player.

15. The method of claim 9, wherein the sound source data is any one of an MP3 file, a Window Media Audio (WMA) file, and a Wave (WAV) file.

16. A Bluetooth® system comprising:
a headset used for listening to sound source data received by Bluetooth; and
a host apparatus for performing Pulse Code Modulation (PCM) on sound source data and transmitting the modulated sound source data to the headset when a type of the headset is a mono headset.

17. The Bluetooth® system of claim 16, wherein the host apparatus performs Universal Asynchronous Receiver Transmitter (UART) modulation on the sound source data when a type of the headset is not a mono headset.

18. The Bluetooth® system of claim 16, wherein the host apparatus is any one of a mobile phone, a Personal Digital Assistant (PDA), a laptop computer, and an MPEG Audio Layer-3 (MP3) player.

19. The Bluetooth® system of claim 16, wherein the host apparatus stores the sound source data is sound source data in a memory.

20. The Bluetooth® system of claim 16, wherein the sound source data is any one of an MP3 file, a Window Media Audio (WMA) file, and a Wave (WAV) file.
